(19) United States
(12) Patent Application Publication
(10) Pub. No.: US 2020/0321662 A1
(43) Pub. Date: Oct. 8, 2020

(54) HIGH TEMPERATURE LITHIUM AIR BATTERY

(71) Applicant: Johnson IP Holding, LLC., Atlanta, GA (US)

(72) Inventor: Lonnie G. JOHNSON, Atlanta, GA (US)

(21) Appl. No.: 16/838,706

(22) Filed: Apr. 2, 2020

Related U.S. Application Data
(60) Provisional application No. 62/829,108, filed on Apr. 4, 2019.

(51) Int. Cl. H01M 10/39; H01M 10/0525; H01M 10/0563

(52) U.S. Cl. CPC H01M 10/39; H01M 10/0563; H01M 10/0525

(57) ABSTRACT

A rechargeable lithium air battery contains a lithium based anode containing a lithium ion conductive electrolyte forming a first chamber that encloses lithium metal, an oxygen electrode, a solid oxygen ion conductive electrolyte forming a second chamber, and a molten electrolyte contained in the second chamber and coupled between the oxygen ion conductive electrolyte and the lithium ion conductive electrolyte, and the molten salt electrolyte has no contact with air.

### CROSS-REFERENCE TO RELATED APPLICATION

This application claims priority to co-pending U.S. Provisional Application No. 62/829,108, filed Apr. 4, 2019, the disclosure of which is herein incorporated by reference.

### BACKGROUND OF THE INVENTION

The need for high performance and reliable energy storage in the modern society is well documented. Lithium batteries represent a very attractive solution to these energy needs due to their superior energy density and high performance. However, available Li-ion storage materials limit the specific energy of conventional Li-ion batteries. While lithium has one of the highest specific capacities of any anode (3861 mAh/g), typical cathode materials such as MnO₂, V₂O₅, LiCoO₂ and (CF)n have specific capacities less than 200 mAh/g.

Recently, lithium/oxygen (Li/O₂) or lithium air batteries have been suggested as a means for avoiding the limitations of today's lithium ion cells. In these batteries, lithium metal anodes are used to maximize anode capacity and the cathode capacity of Li air batteries is maximized by not storing the cathode active material in the battery. Instead, ambient O₂ is reduced on a catalytic air electrode to form O₂²⁻, where it reacts with Li⁺ ions conducted from the anode. Aqueous lithium air batteries have been found to suffer from corrosion of the Li anode by water and suffer from less than optimum capacity because of the excess water required for effective operation.

Abraham and Jiang (J. Electrochem. Soc., 143 (1), 1-5 (1996)) reported a non-aqueous Li/O₂ battery with an open circuit voltage close to 3 V, an operating voltage of 2.0 to 2.8 V, good coulomb efficiency, and some re-chargeability, but with severe capacity fade, limiting the lifetime to only a few cycles. Further, in non-aqueous cells, the electrolyte has to wet the lithium oxygen reaction product in order for it to be electrolyzed during recharge. It has been found that the limited solubility of the reaction product in available organic electrolytes necessitates the use of excess amounts of electrolyte to adequately wet the extremely high surface area nanoscale discharge deposits produced in the cathode. Thus, the required excess electrolyte significantly decreases high energy density that would otherwise be available in lithium oxygen cells.

Operation of Li/02 cells depends on the diffusion of oxygen into the air cathode. As such, high oxygen solubility in the electrolyte is desired for the cell to operate under high rate discharge conditions. J. Read (J. Electrochem. Soc., 149(9) A1190-A1195 (2002)), in studying the cathodes of lithium air cells, demonstrated the dependence of cathode capacity on oxygen absorption. Oxygen absorption is a function of electrolyte Bunsen coefficient (α), electrolyte conductivity (σ), and viscosity (η). The trend of decreasing cathode lithium reaction capacity with increasing viscosity and decreasing Bunsen coefficient is apparent in Read's data. It is known that as the solvent's viscosity increases, there are decreases in lithium reaction capacity and Bunsen coefficients. Additionally, the electrolyte has an even more direct effect on overall cell capacity as the ability to dissolve reaction product is crucial. This problem has persisted in one form or another in known batteries.

Indeed, high rates of capacity fade remain a problem for non-aqueous rechargeable lithium air batteries and have represented a significant barrier to their commercialization. The high fade is attributed primarily to parasitic reactions occurring between the electrolyte and the mossy lithium powder and dendrites formed at the anode-electrolyte interface during cell recharge, as well as the passivation reactions between the electrolyte and the LiO₂ radical which occurs as an intermediate step in reducing Li₂O₂ during recharge.

During recharge, lithium ions are conducted across the electrolyte separator with lithium being plated at the anode. The recharge process can be complicated by the formation of low density lithium dendrites and lithium powder as opposed to a dense lithium metal film. In addition to passivation reactions with the electrolyte, the mossy lithium formed during recharge can be oxidized in the presence of oxygen into mossy lithium oxide. A thick layer of lithium oxide and/or electrolyte passivation reaction product on the anode can increase the impedance of the cell and thereby lower performance. Formation of mossy lithium with cycling can also result in large amounts of lithium being disconnected within the cell and thereby being rendered ineffective. Lithium dendrites can penetrate the separator, resulting in internal short circuits within the cell. Repeated cycling causes the electrolyte to break down, in addition to reducing the oxygen passivation material coated on the anode surface. This results in the formation of a layer composed of mossy lithium, lithium-oxide and lithium-electrolyte reaction products at the metal anode's surface which drives up cell impedance and consumes the electrolyte, bringing about cell dry out.

Attempts to use active (non-lithium metal) anodes to eliminate dendritic lithium plating have not been successful because of the similarities in the structure of the anode and cathode. In such lithium air “ion” batteries, both the anode and cathode contain carbon or another electronic conductor as a medium for providing electronic continuity. Carbon black in the cathode provides electronic continuity and reaction sites for lithium oxide formation. To form an active anode, graphitic carbon is included in the anode for intercalation of lithium and carbon black is included for electronic continuity. Unfortunately, the use of graphite and carbon black in the anode can also provide reaction sites for lithium oxide formation. At a reaction potential of approximately 3 volts relative to the low voltage of lithium intercalation into graphite, oxygen reactions would dominate in the anode as well as in the cathode. Applying existing lithium ion battery construction techniques to lithium oxygen cells would allow oxygen to diffuse throughout all elements of the cell structure. With lithium/oxygen reactions occurring in both the anode and cathode, creation of a voltage potential differential between the two is difficult. An equal oxidation reaction potential would exist within the two electrodes, resulting in no voltage.

As a solution to the problem of dendritic lithium plating and uncontrolled oxygen diffusion, known aqueous and non-aqueous lithium air batteries have included a barrier electrolyte separator, typically a ceramic material, to protect the lithium anode and provide a hard surface onto which lithium can be plated during recharge. However, formation of a reliable, cost effective barrier has been difficult. A lithium air cell employing a protective solid state lithium ion conductive barrier as a separator to protect lithium in a lithium air cell is described in U.S. Pat. No. 7,691,536 of Johnson. Thin film barriers have limited effectiveness in withstanding the mechanical stress associated with stripping and plating lithium at the anode or the swelling and contraction of the cathode during cycling. Moreover, thick lithium ion conductive ceramic plates, while offering excellent protective barrier properties, are extremely difficult to fabricate, add significant mass to the cell, and are rather expensive to make.

Thick lithium ion conductive ceramic plates have also been employed, particularly in lithium water cells. Having thicknesses in the range of 150 um, these plates offer excellent protective barrier properties, however, they are difficult to fabricate and expensive. In addition, these ceramic plates add significant mass to the cell, resulting in a reduction in specific energy storage capability. This reduction can be sufficient to negate the otherwise high energy density performance available using lithium-air technology.

As it relates to the cathode, the dramatic decrease in cell capacity as the discharge rate is increased is attributed to the accumulation of reaction product in the cathode. At high discharge rate, oxygen entering the cathode at its surface does not have an opportunity to diffuse or otherwise transition to reaction sites deeper within the cathode. The discharge reactions occur at the cathode surface, resulting in the formation of a reaction product crust that seals the surface of the cathode and prevents additional oxygen from entering. Starved of oxygen, the discharge process cannot be sustained.

Another significant challenge with lithium air cells has been electrolyte stability within the cathode. The primary discharge product in lithium oxygen cells is Li₂O₂. During recharge, the resulting lithium oxygen radical, LiO₂, an intermediate product which occurs while electrolyzing Li₂O₂, aggressively attacks and decomposes the electrolyte within the cathode, causing it to lose its effectiveness.

High temperature molten salts have been suggested as an alternative to organic electrolytes in non-aqueous lithium-air cells. U.S. Pat. No. 4,803,134 of Sammells describes a high lithium-oxygen secondary cell in which a ceramic oxygen ion conductor is employed. The cell includes a lithium-containing negative electrode in contact with a lithium ion conducting molten salt electrolyte, LiF—LiCl—Li₂O, separated from the positive electrode by the oxygen ion conducting solid electrolyte. The ion conductivity limitations of available solid oxide electrolytes require that such a cell be operated in the 700° C. range or higher in order to have reasonable charge/discharge cycle rates. The geometry of the cell is such that the discharge reaction product accumulates within the molten salt between the anode and the solid oxide electrolyte. The required space is an additional source of impedance within the cell.

Molten nitrates also offer a viable solution and the physical properties of molten nitrate electrolytes are summarized in Table 1 (taken from Lithium Batteries Using Molten Nitrate Electrolytes by Melvin H. Miles; (1999)).

TABLE 1
Physical properties of Molten Nitrate Electrolytes

| | | Melt Temp | κ (S/cm) | |
|---|---|---|---|---|
| System | Mol % | ° C. | @570K | at Mol % |
| LiNO₃—KNO₃ | 42-58 | 124 | 0.687 | 50.12 mol % |
| | | | | LiNO₃ |
| LiNO₃—RbNO₃ | 30-70 | 148 | 0.539 | 50 mol % |
| | | | | RbNO₃ |
| NaNO₃—RbNO₃ | 44-56 | 178 | 0.519 | 50 mol % |
| | | | | RbNO₃ |
| LiNO₃—NaNO₃ | 56-44 | 187 | 0.985 | 49.96 mol % |
| | | | | NaNO₃ |
| NaNO₃—KNO₃ | 46-54 | 222 | 0.66 | 50.31 mol % |
| | | | | NaNO₃ |
| KNO₃—RbNO₃ | 30-70 | 290 | 0.394 | 70 mol % |
| | | | | RbNO₃ |

The electrochemical oxidation of the molten LiNO₃ occurs at about 1.1 V vs. Ag+/Ag or 4.5 V vs. Li+/Li. The electrochemical reduction of LiNO₃ occurs at about −0.9V vs. Ag+/Ag, and thus these two reactions define a 2.0V electrochemical stability region for molten LiNO₃ at 300° C. and are defined as follows:

LiNO₃→Li⁺+NO₂+½O₂+e⁻ (Equation 1)

LiNO₃+2e⁻→LiNO₂+O⁻⁻ (Equation 2)

The work with molten nitrates was not performed with lithium air cells in mind; however, the effective operating voltage window for the electrolyte is suitable for such an application. As indicated by the reaction potential line in Scheme 1, applying a recharge voltage of 4.5V referenced to the lithium anode can cause lithium nitrate to decompose to lithium nitrite, releasing oxygen. On the other hand, lithium can reduce LiNO₃ to Li₂O and LiNO₂. This reaction occurs when the LiNO₃ voltage drops below 2.5V relative to lithium. As long as there is dissolved oxygen in the electrolyte, the reaction kinetics will favor the lithium oxygen reactions over LiNO₃ reduction. Oxide ions are readily converted to peroxide (O₂²⁻) and aggressive superoxide (O₂⁻) ions in NaNO₃ and KNOB melts (M. H. Miles et al., J. Electrochem. Soc., 127, 1761 (1980)).

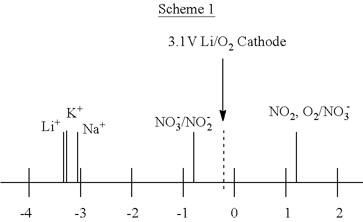 [SMILES: [K+] ; [Li+] ; [Na+]]

In 2015, Vincent Giordani of Liox Power, Inc. reported high temperature molten salt system using nitrates. Nitrate and halide salts have the stability needed for the lithium oxygen environments, high ion conductivity and the ability to dissolve lithium oxygen and lithium carbonate reaction products. The challenge faced with these systems is primarily associated with disposition of reaction products. Similar to the non-aqueous, organic electrolyte cells, accumulation of discharge reaction product within the cell tends to interfere with migration of reactants to reaction sites and thereby limit cell performance.

A need remains for a lithium air cell which overcomes problems associated with those of the prior art.

### BRIEF SUMMARY OF THE INVENTION

A rechargeable lithium air battery according to an embodiment of the disclosure contains a lithium based anode containing a solid lithium ion conductive electrolyte forming a first chamber that encloses lithium metal, an oxygen electrode, a solid oxygen ion conductive electrolyte forming a second chamber, and a molten electrolyte contained in the second chamber and coupled between the oxygen ion conductive electrolyte and the lithium ion conductive electrolyte, and the molten salt electrolyte has no contact with air.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic of a battery cell according to one embodiment of the present disclosure undergoing discharge;

FIG. 2 is a schematic of a battery cell according to one embodiment of the present disclosure undergoing recharge;

FIG. 3 is an Arrhenius plot showing lithium ion conductivities of several solid ceramic electrolytes;

FIG. 4 is an Arrhenius plot showing oxygen ion conductivities of several solid ceramic electrolytes;

FIG. 5 is a graph showing the ionic conductivity of several alkali eutectic salt electrolytes;

FIG. 6 is an Arrhenius plot of lithium ion conductivity of lithium oxide;

FIG. 7 is a diagram showing rough dimensions for an exemplary embodiment of the present disclosure; and

FIG. 8 is a table of mass and volume allocations for an exemplary embodiment of the present disclosure.

### DETAILED DESCRIPTION OF THE INVENTION

This disclosure generally relates to energy storage, and more particularly to a lithium air electrochemical cell. For the purposes of this disclosure, the terms lithium air cell, lithium air battery, lithium air electrochemical engine, rechargeable lithium air battery, and lithium oxygen battery are used interchangeably.

Certain terminology is used in the following description for convenience only and is not limiting. The words “proximal,” “distal,” “upward,” “downward,” “bottom” and “top” designate directions in the drawings to which reference is made. The words “inwardly” and “outwardly” refer to directions toward and away from, respectively, a geometric center of the device, and designated parts thereof, in accordance with the present invention. Unless specifically set forth herein, the terms “a,” “an” and “the” are not limited to one element, but instead should be read as meaning “at least one.” The terminology includes the words noted above, derivatives thereof and words of similar import.

It will also be understood that terms such as “first,” “second,” and the like are provided only for purposes of clarity. The elements or components identified by these terms, and the operations thereof, may easily be switched.

Aspects of the disclosure relate to a lithium air battery which exhibits a high rate of cell charge/discharge with limited capacity fade, high energy density, high power density and the ability to operate on oxygen from ambient air. As such it removes significant barriers that have prevented the commercialization of lithium air cells. For example, the mossy lithium powder and dendrites at the anode-electrolyte interface formed during cell recharge are eliminated by using molten lithium supplied as a flow reactant to the anode side of a stable solid state ceramic electrolyte. A flow system for removing reaction product from the cathode is also described.

The reactions of lithium with oxygen are as follows:

2Li+O₂→Li₂O₂ Eₒ=3.10 V

4Li+O₂→2Li₂O Eₒ=2.91V

To avoid the problems associated with past approaches to lithium air cells, aspects of the disclosure include a lithium air cell that operates at elevated temperature, in the wide range of about 250° C. to 650° C., more preferably about 250° to 400° C. or about 400° C. to 650° C., depending on the specific electrolyte contained in the battery. Specifically, as described in further detail below, the lower operating temperature range is preferred when the molten electrolyte contains siloxanes and the higher operating temperature range is preferred when the electrolyte contains only inorganic molten salts. Operation at elevated temperature enables faster kinetics for higher power density, thus eliminating a major problem associated with lithium air technology. Further, operation at elevated temperature also allows the use of high temperature organic electrolytes and inorganic, molten salt electrolyte solutions that have high electrochemical stability, thus avoiding another of the major problems that has plagued the conventional approach to lithium air cells. Selected inorganic molten salts have good solubility of lithium/oxygen reaction products, thus allowing better control of cell kinetics.

The rechargeable lithium air battery according to aspects of the disclosure contains a lithium based anode comprising a lithium ion conductive electrolyte forming a first chamber that encloses lithium metal, an oxygen electrode, a solid oxygen ion conductive electrolyte forming a second chamber, and a molten electrolyte contained in the second chamber and coupled between the oxygen ion conductive electrolyte and the lithium ion conductive electrolyte, in which the molten electrolyte has no contact with air. Each of these components will be described in more detail below.

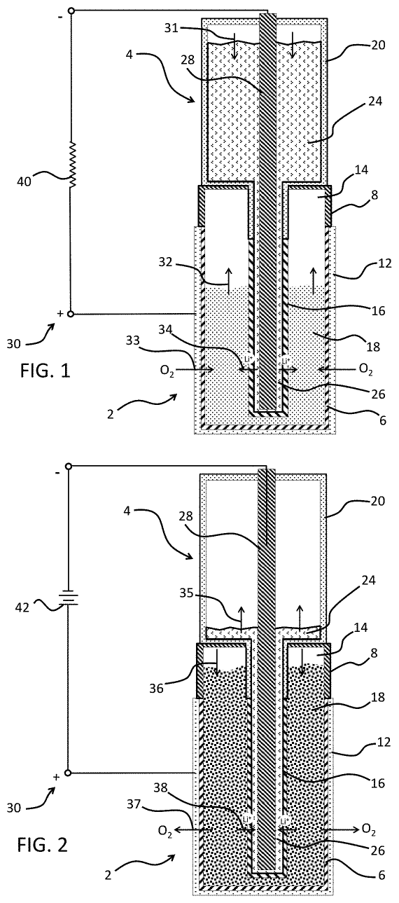

The embodiment of the disclosure shown in FIG. 1 includes electrolyte/reaction product enclosure 2 and lithium enclosure 4. Lithium enclosure 4 is comprised of lithium ion conductive ceramic electrolyte 16 and expansion reservoir 20. Solid lithium ion conductive electrolyte 16 extends into reaction product enclosure 2. Enclosure 4 contains molten lithium 24 and negative electrode current collector 28. The molten lithium contained within enclosure 4 extends into lithium ion conductive electrolyte section 16, see 26. Electrolyte enclosure 2 is comprised of oxygen ion conductive solid electrolyte 6 and expansion reservoir 8. Oxygen electrode 12 is coupled to the exterior surface of oxygen ion conductive electrolyte 6 and functions as the positive electrode of the cell. Negative electrode 28 and positive electrode 12 are electrically coupled to terminals 30. Molten salt electrolyte 18 is contained inside electrolyte enclosure 2 and couples oxygen ion conductive electrolyte 6 to the exterior surface of solid lithium ion conductive electrolyte 16.

FIG. 1 shows the cell in a charged state and undergoing discharge. The level of lithium 24 within reservoir 20 is high and is being consumed as indicated by arrow 31 as lithium is oxidized along the inner surface of electrolyte 16. The resulting electrons are conducted by electrode 28 to terminals 30 while, as indicated by arrows 34, the lithium ions are conducted through electrolyte 16 and on into molten salt electrolyte 18. The electrons are conducted through load 40 at terminals 30 and thereafter to oxygen electrode 12. Oxygen is oxidized at the oxygen electrode 12 interface with oxygen ion conductive electrolyte 6. The resulting oxygen ions are conducted through electrolyte 6 and into molten salt electrolyte 18, thereby completing the reaction with lithium entering through electrolyte 16 to form lithium oxide. As lithium reaction product accumulates within electrolyte enclosure 2 the level of the resulting mixture of molten salt/lithium oxygen reaction product rises as indicated by arrows 32.

FIG. 2 shows the cell in a discharged state and undergoing recharge. It may be seen that the level of lithium-oxygen reaction product accumulated within molten salt electrolyte 18 is much higher and the mixture now extends into reservoir 8. The level of molten lithium metal 24 within reservoir 20 is now low. The cell is recharged by power source 42 as the applied voltage electrolyzes lithium oxide dispersed within electrolyte 18. Lithium ions are conducted through electrolyte 16 and reduced by electrons supplied by electrode 28 from power source 42. As reduced lithium accumulates within interior lithium enclosure 4, the level of molten lithium rises as indicated by arrows 35. At the same time, power source 42 reduces oxygen ions at the oxygen ion conductive electrolyte 6-electrode 12 interface as electrons are extracted by power source 42. During recharge, the volume of the mixture of molten salt and lithium oxygen reaction product reduces as indicated by arrows 36. During recharge, the cell eventually returns to its original state illustrated in FIG. 1.

### Solid Lithium Ion Conductive Electrolyte 16

The solid lithium ion conductive electrolyte is preferably a ceramic material which is stable in contact with lithium metal and forms a chamber or enclosure for containing the lithium metal. Together with the lithium metal, the solid lithium ion conductive electrolyte forms the anode for the battery.

FIG. 3 is an Arrhenius graph including data from Li Gaoran, et. al., (Front. Energy Res., 11 (2015)) and M Kotobuki, et. al., (Journal of Power Sources 196 7750-7754 (2011)) and provides the conductivities of several solid state lithium ion conductive electrolyte materials that may be selected for use as the lithium ion conductive electrolyte.

Preferred materials for the solid lithium ion conductive electrolyte include lithium ion conducting glasses such as lithium beta alumina, lithium phosphate glass, lithium lanthanum zirconium oxide (LLZO), alumina doped LLZO (Al₂O₃:Li₇La₃Zr₂O₁₂), lithium silicon phosphate (Li₇SiPO₈), lithium aluminum germanium phosphate (LAGP), and lithium aluminum titanium phosphate (LATP). The most preferred material is lithium silicon phosphate.

In a preferred embodiment, the anode chamber which is formed from the solid lithium ion conductive electrolyte is maintained at relatively uniform temperature.

### Solid Oxygen Ion Conductive Electrolyte 6

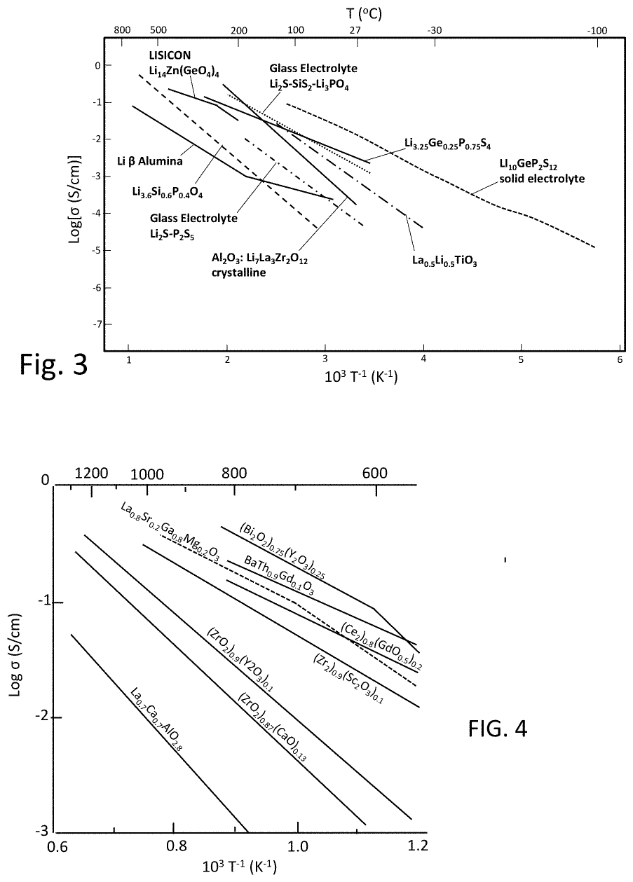

The solid oxygen ion conductive electrolyte forms a chamber for the molten salt electrolyte. Preferred materials for the solid oxygen ion conductive electrolyte include ceramics such as, but not limited to, scandium-stabilized zirconia (SSZ) and yttria-stabilized zirconia (YSZ), stabilized by either 3 mol % Y₂O₃ (3YSZ) or 8 mol % Y₂O₃ (8YSZ). FIG. 4, reproduced from Ma et al. (Ph.D. thesis, Stockholm, 2012), shows the oxygen ion conductivities of several materials which are appropriate for use as solid oxygen ion conductive electrolytes in the lithium air batteries described herein.

Although illustrated in FIGS. 1 and 2, it is not necessary for the solid ion conductive electrolyte to be in direct contact with the molten electrolyte.

### Air Cathode/Oxygen Electrode 12

The air cathode or oxygen electrode is porous so that oxygen can flow through the pores to and from reaction sites where it is oxidized or reduced as the cell is discharged or charged respectively. During discharge, oxygen enters the cell by flowing to oxidation sites where it is oxidized into oxygen ions and electrons. The electrons are conducted through load 40 to anode electrode terminal 28. The oxygen ions are conducted through solid electrolyte 6 into molten electrolyte 18. The opposite occurs during charge. Oxygen ions are conducted from the molten electrolyte through solid electrolyte 6 to reaction sites in the cathode where it is reduced to oxygen and released to external air.

The cathode may be constructed of an electrically conductive sintered metal oxide, such as lanthanum strontium iron oxide, lanthanum strontium iron cobalt oxide (LSCF), praseodymium strontium iron oxide (PSF), barium strontium cobalt iron oxide (BSCF), lanthanum strontium copper oxide (LSC), and lanthanum strontium manganese oxide (LSM). The preferred cathode material is LSM. It is also within the scope of the disclosure for the cathode to include silver or other suitable electron conductive materials.

### Molten Electrolyte 18

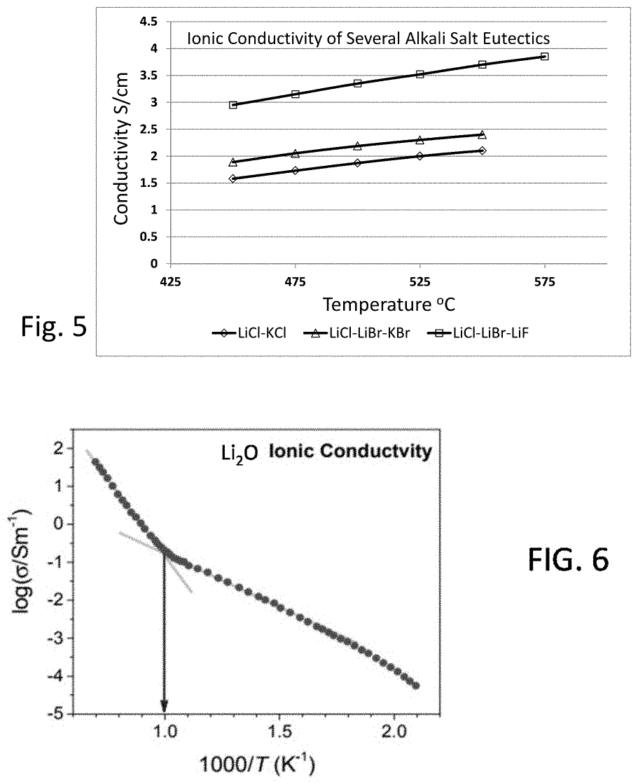

The molten electrolyte is preferably an inorganic molten salt eutectic. FIG. 5 is a graph of several inorganic molten salts that are suitable for use in the invention, reproduced from Masset et al. (Journal of Power Sources 164; 397-414 (2007)). Of the eutectic salt melts shown on the chart, LiF—LiCl—LiBr (9.6-22-68.4) has the highest conductivity, 3.5 S/cm at 500° C. Molten salts such as LiF—LiCl—LiBr have the advantage of solvating the lithium-oxygen (Li₂O and Li₂O₂) reaction products, a significant benefit when charging and discharging the cell. When the salt is saturated with discharge product, the discharge product will precipitate out of solution as it continues to accumulate within molten salt 18.

Alternate example molten electrolytes include lithium metaborate, lithium orthoborate, lithium tetraborate, LiPON in bulk form, lithium fluoride doped lithium metaborate, silicon doped lithium tetraborate, lithium metaborate doped lithium carbonate (LiBO₂—Li₂CO₃), lithium orthoborate doped lithium carbonate (Li₃BO₃—Li₂CO₃), lithium carbonate doped lithium orthoborate (Li₂CO₃—Li₃BO₃), silicon dioxide doped Li₃BO₃—Li₂CO₃ (SiO₂—Li₃BO₃—Li₂CO₃), and lithium fluoride doped Li₃BO₃—Li₂CO₃ (LiF—Li₃BO₃—Li₂CO₃). Other example electrolytes include molten inorganic salts, for example, alkali nitrates such as lithium and sodium nitrate, alkali chlorides and bromides such as lithium, potassium and sodium chlorides and bromides, alkali carbonates such as sodium and lithium carbonates, as well as eutectic mixtures such as sodium nitrate-potassium nitrate (NaNO₃—KNO₃) and lithium chloride-potassium chloride (LiCl—KCl) eutectic for operating in the 400 to 650° C. temperature range and silane and siloxane-based compounds including, for example, hexamethylcyclotrisiloxane, octamethylcyclotetrasiloxane, decamethylcyclopentasiloxane, and dodecamethylhexatetrasiloxane with or without polyethylene oxide groups for operating in the 250 to 400° C. temperature range. Particularly preferred materials include doped Li_{9.3}C₃BO_{12.5} (LCBO), such as LCBFO (LCBO doped with fluorine), LCBSO (LCBO doped with sulfur), LBCSiO (LCBO doped with silicon), LBCSiFO (LBCSiO doped with fluorine) and LBCGeO (LCBO doped with germanium), as well as LBCSO (LBCO doped with sulfur) for operating in the 400 to 650° C. temperature range.

FIG. 6 is a graph of the ionic conductivity of lithium oxide. This data is provided by Annamareddy, et. al. (Entropy, 19, 227 (2017)). Assuming an operating temperature of 500° C., lithium oxide would have an ionic conductivity of 10-1.5 at 500° C. The ionic conductivity will be a blended value for the molten salt and solid lithium oxide reaction product mixture.

The non-aqueous electrolyte is chosen for stability in contact with lithium. Thus, a breach in the lithium conductive enclosure will not result in rapid reactions, particularly because oxygen ingress into the cell will be controlled.

### Anode

The lithium based anode is comprised of lithium contained in a sealed ceramic enclosure or chamber formed by the solid lithium ion conductive electrolyte. The anode comprises metallic lithium in a molten state; lithium has a melting point of about 180° C. Lithium metal is stable in direct contact with the molten salt electrolyte because there is no oxygen gas or air inside the molten salt enclosure. The benefit of the molten lithium anode within the ion conductive enclosure is that it limits undesirable dendrite growth and short circuits in the cell. The solid lithium electrolyte enclosure maintains lithium in a contiguous state so that all of the molten lithium remains in electrical contact with the anode terminal. During discharge, lithium is oxidized into lithium ions and electrons at the solid electrolyte interface. The electrons are conducted through load 40 to cathode electrode terminal 30. The lithium ions are conducted through solid electrolyte 16 into molten electrolyte 18 with oxygen ions being simultaneously conducted through the oxygen ion conductive enclosure. The opposite occurs during charge. Lithium ions are conducted from the molten salt through molten electrolyte 18 and reduced to lithium metal within reservoir 20 as electrons are coupled to terminal 28 from positive electrode 12.

Oxygen ions are conducted into the molten salt through the wall of the molten salt enclosure, which is oxygen ion conductive, and the molten salt does not contact air. There is no direct contact between the molten salt and the air, so that there is no evaporation of the molten salt from the cell. Oxygen is iodized into ions at the outer surface of the containment chamber and conducted through the solid containment wall into the molten salt.

### Exemplary Design

An exemplary design is a 1875 kWh battery designed for maximum power output at a discharge rate of 1C, i.e., the battery totally discharges in 1 hour. Lithium has a specific energy of 11,580 Wh/kg. For a 1.875 kWh cell, 162 g of lithium is needed. Lithium has a discharge current capacity of 3.86 Ah/g so that the Amp-hour capacity of the cell would be 625 Ah, (162 g*3.86 Ah/g/1 hr).

Because of its operating temperature, the primary reaction product of the cell is Li₂O. The atomic mass of lithium is 6.9 g/mole. For the 4Li+O₂>2Li₂O discharge reaction product, 0.5 mole of oxygen is required for per mole of lithium. Assuming 162 g (23.48 moles) lithium, 11.74 moles (187.82 g) of oxygen are required to balance the reaction. If the mass of the oxygen is included, the net energy density is 5,385 Wh/kg for lithium oxide (Li₂O) as the reaction product.

The amount of air flow required to sustain a 1C discharge rate can be determined from the required oxygen flow. Air is 23% oxygen by mass so that the total amount of air needed for the reaction is 816.6 g (187.82 g O₂/(0.23 g O₂/g Air). For the 1C discharge, the air mass flow rate is 816.6 g/hr or 0.23 g/sec, and using the density of air of 0.00123 g/cm³ yields a volumetric flow rate of 187 cm³/sec.

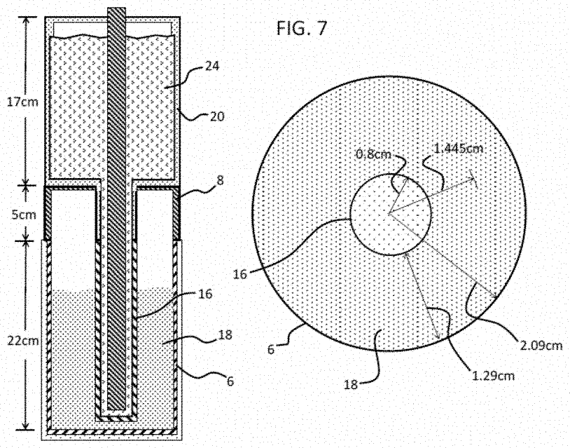

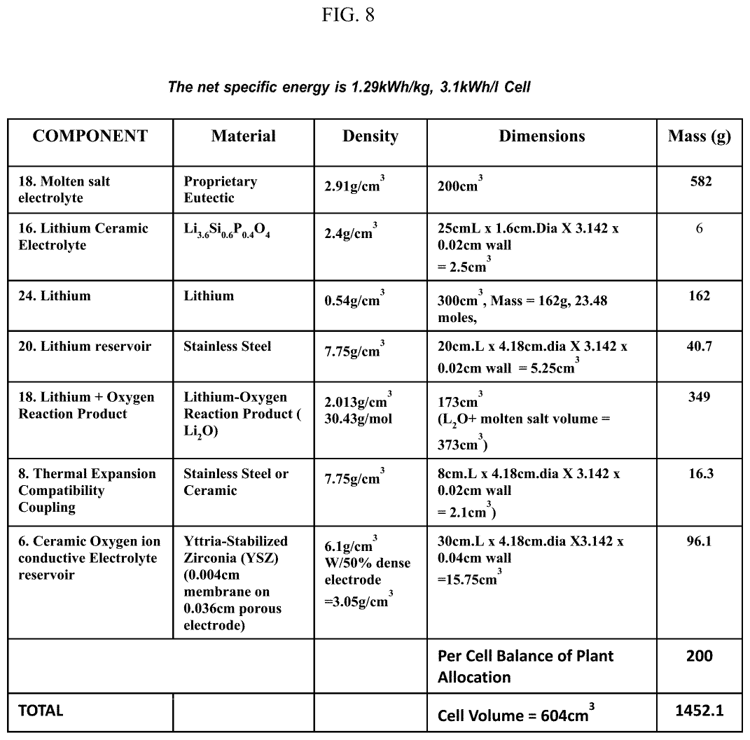

Referring to FIG. 7 as a rough estimate and assuming a 0.8 cm radius for solid lithium electrolyte container/separator 16 with a mean effective height of 22 cm, the mean effective surface area would be 55 cm². The max power output current applied across a 110 cm² separator would result in a net current density of 5.6 A/cm² (625 Ah/1 h/110 cm²). As shown in FIG. 3, the lithium ion conductivity, σ, of Li_{3.6}Si_{0.6}P_{0.4}O₄ at 600° C. is approximately 1×10^{-0.3} S/cm. A separator made of this material and at a thickness, t, of 200 microns would have an impedance of 0.04 Ohm-cm², (1/σ*t, 1/10^{-0.3}*0.02 cm). The maximum power output current would have a maximum voltage drop of 0.22 volts (5.6 A*0.040 hms) across electrolyte 16.

The conductivity of the molten salt electrolyte 18 at 600° C. is 4 S/cm as shown in FIG. 5. Its mean current density can be determined using its mean diameter. Referring to FIG. 7, the difference between the radius of electrolyte 16 and electrolyte 6 is 1.29 cm. Half of this thickness would be 0.645 cm, which gives a molten electrolyte midpoint radius of 1.445 cm. The equivalent surface area at that radius is 200 cm2 (2π*1.445 cm*22 cm). At the molten salt's midpoint radius of 1.445 cm, the max power current density would be 3.13 A/cm², (625 Ah/1 h/200 cm²). For the molten salt electrolyte thickness of 1.29 cm and conductivity of 4 S/cm, the resistance is 0.32 Ohm·cm², (1.29 cm ohm/4/cm). At a current density of 3.13 A/cm², the max power voltage drop across the molten salt will be 1 volt.

Using scandium stabilized zirconia [(Zr2)0.9(Sc2O3)0.1, SSZ] as the oxygen ion conducting electrolyte 6, the surface area at a radius of 2.09 cm is 288 cm² (2π*2.09 cm*22 cm) and the maximum power current density at this radius is 2.17 A/cm2 (625 Ah/1 h/288 cm²). From FIG. 4, the conductivity of SSZ at 600° C. is 10^{-1.69} S/cm. For a thickness of 0.004 cm, the resistance for the oxygen conductive containment would be 0.2 Ohms·cm². At a current density of 2.17 A/cm², the voltage drop will be 0.434 volts.

For this example, the total voltage drop relative to open circuit voltage during a high rate, 1 hour full discharge will be 1.65 volts.

The energy density can be approximated by considering the mass of the components needed to construct the cell. FIG. 8 presents materials and mass allocations for the various components of the cell illustrated in FIGS. 1, 2 and 7 with the major components identified by drawing reference number in the component column. It may be seen that the mass impact of the molten salt electrolyte at 582 grams is the biggest factor in determining specific energy. Excess electrolyte is necessary in order to maintain the Li₂O reaction product in a slurry suspension in so that the level of product within reservoir 6 can freely rise and fall with discharge and charge respectively.

The biggest single material impacting volumetric energy density is lithium at 300 cm³. A volume of 437 cm³ has be allocated within electrolyte reservoirs 6 and 8 to accommodate the 200 cm³ of molten salt plus 173 cm³ of lithium-oxygen reaction product at full discharge. The assessment allocated 200 grams for balance of plant components that may be shared with other cells within an overall battery system including an air blower and conduits, thermal insulation, recuperative heat exchange, electrodes and terminal interconnects.

Based on this example analysis, the approximate volumetric energy density is 3.1 kWh/l, (1,875 Wh/604 cm³) and the fully discharged specific energy is 1.29 kWh/kg. It should be noted that reducing the molten salt allocation to 300 grams would result in a fully discharged specific energy of 1.6 kWh/kg.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A rechargeable lithium air battery comprising a lithium based anode comprising a solid lithium ion conductive electrolyte forming a first chamber that encloses lithium metal, an oxygen electrode, a solid oxygen ion conductive electrolyte forming a second chamber, and a molten electrolyte contained in the second chamber and coupled between the oxygen ion conductive electrolyte and the lithium ion conductive electrolyte, wherein the molten salt electrolyte has no contact with air.

2. The rechargeable lithium air battery according to claim 1, further comprising an oxygen source, wherein the oxygen ion conductive electrolyte is exposed to the oxygen source.

3. The rechargeable lithium air battery according to claim 1, further comprising a lithium source, wherein the lithium ion conductive electrolyte is exposed to the lithium source.

4. The rechargeable lithium air battery according to claim 1, wherein the solid lithium ion conductive electrolyte comprises lithium silicon phosphate (Li₇SiPO₈).

5. The rechargeable lithium air battery according to claim 1, wherein the molten electrolyte is a molten alkali metal salt electrolyte and comprises at least one of Li_{9.3}C₃BO_{12.5}, LiF—LiCl—LiBr, fluorine-doped Li_{9.3}C₃BO_{12.5}, and sulfur-doped Li_{9.3}C₃BO_{12.5}.

6. The rechargeable lithium air battery according to claim 1, wherein the battery has an operating temperature of about 250° C. to about 650° C.

7. The rechargeable lithium air battery according to claim 6, wherein the battery has an operating temperature of about 250° C. to about 400° C.

8. The rechargeable lithium air battery according to claim 1, wherein the battery has an operating temperature of about 400° C. to about 650° C.

9. The rechargeable lithium air battery according to claim 1, wherein the solid oxygen ion conductive electrolyte is scandium-stabilized zirconia or yttria-stabilized zirconia.

10. The rechargeable lithium air battery according to claim 1, wherein the oxygen electrode is porous.

11. The rechargeable lithium air battery according to claim 1, wherein the oxygen electrode comprises an electrically conductive metal oxide.

12. The rechargeable lithium air battery according to claim 11, wherein the oxygen electrode comprises lanthanum strontium metal oxide.

13. The rechargeable lithium air battery according to claim 1, wherein the molten electrolyte is a silane or siloxane.
